(19) United States
(12) Patent Application Publication
(10) Pub. No.: US 2011/0015074 A1
(43) Pub. Date: Jan. 20, 2011

(54) STABILIZED HERBICIDAL FORMULATIONS AND METHODS OF USE

(76) Inventor: Carlton Stephen Seckinger, Valdosta, GA (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 12/505,872

(22) Filed: Jul. 20, 2009

(51) Int. Cl. A01N 35/10; A01N 43/16; A01N 43/02

(52) U.S. Cl. 504/288; 504/344; 504/292

(57) ABSTRACT

The invention relates to formulations including a combination of an active herbicide, in particular, a cyclohexanedione oxime herbicide, and a stabilizer. The formulations, for example, have improved stability. The invention further relates to methods for controlling weeds. The invention additionally provides methods for producing a stabilized herbicidal composition.

### FIELD OF THE INVENTION

The invention relates to formulations including a combination of an active herbicide, in particular, a cyclohexanedione oxime herbicide, and a stabilizer. The formulations, for example, have improved stability. The invention further relates to methods for controlling weeds. The invention additionally provides methods for producing a stabilized herbicidal composition.

### INTRODUCTION

The invention relates to an herbicidal composition having improved storage stability and containing a cyclohexanedione oxime as an active compound and a stabilizer.

Certain cyclohexanedione oximes have herbicidal activity against a variety of post-emergent grass weeds. Examples of cyclohexanedione oximes include clethodim, sethoxydim, cycloxydim, alloxydim, tralkoxydim, tepraloxydim, clefoxydim, clefoxyfim, butroxydim and profoxydim.

The chemical structure of clethodim is shown below in Formula I:

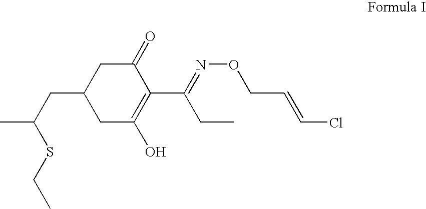

Clethodim is an important commercial herbicide within the class of cyclohexanedione oximes. It is a selective post-emergence cyclohexenone herbicide used to control annual and perennial grasses in a wide variety of broad leaf crops including soybeans, cotton, flax, peanuts, sunflowers, sugarbeets, potatoes, alfalfa and most vegetables. However, environmental factors, such as, soil moisture, elevated temperature, UV and protic compounds contribute to the degradation of clethodim. Water and protic compounds will accelerate the degradation process. A protic compound, such as chloropropenol, which is a degration product of HOCAL, O-(3-Chloro-2-propenyl)hydroxylamine (an impurity in Clethodim) and clethodim, will accelerate degradation. Clethodim is of low persistence in most soils and it is short-lived. The breakdown of clethodim is largely caused by heat, i.e. sunlight, high temperature. The main breakdown products in soils are sulfoxide, sulfone and oxazole sulfone. Clethodim can also rapidly degraded due to the formation of hydrochloric acid by an acid-catalyzed reaction and photolysis in the present of water on the leaf surfaces.

### BRIEF DESCRIPTION OF THE FIGURE

FIG. 1 shows a chemical structure of clethodim.

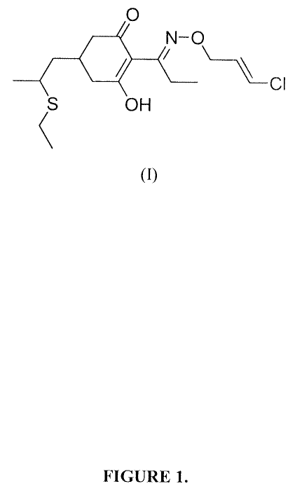

### SUMMARY OF THE INVENTION

The invention provides among other things compositions including a cyclohexanedione oxime or an agriculturally acceptable salt thereof; and an effective amount of a stabilizer. In one embodiment, a stabilizer includes including an epoxidized oil fatty acid or an epoxidized ester of a fatty acid. In another embodiment, a composition further includes a diluent. In another embodiment, a composition further includes one or more adjuvants.

The diluent can be a non-polar solvent. In one embodiment, a non-polar solvent is an aliphatic hydrocarbon, an aromatic hydrocarbon, or an alkyl ester. In another embodiment, a non-polar solvent is an aromatic hydrocarbon. In a further embodiment, an aromatic hydrocarbon is benzene, toluene, xylene, a substituted or an unsubstituted naphthalene, a monoalkylated aromatic, a polyalkylated aromatic, or mixtures thereof. In yet another embodiment, the non-polar solvent is an alkyl ester. In an additional embodiment, an alkyl ester is a methyl ester. In yet a further embodiment, an alkyl ester is a methyl ester of plant oil. In still a further embodiment, a plant oil is canola, linseed, safflower, soybean or a sunflower oil.

An adjuvant may include a crop oil. An adjuvant may also include a surfactant. In one embodiment, a surfactant comprises an anionic surfactant, a nonionic surfactant, or a mixture thereof. An anionic surfactant includes phosphoric mono- and di-esters of long-chain alcohols having 14 to 22 carbon atoms and the salts thereof, phosphoric mono- and di-esters of alkylene oxide addition products of long-chain alcohols having 14 to 22 carbon atoms and the salts thereof, alkylsulfates having 14 to 22 carbon atoms, polyoxyethylene alkyl ether sulfates of alcohols having 14 to 22 carbon atoms, alkane sulfonates having 14 to 22 carbon atoms, or olefin sulfonates having 14 to 22 carbon atoms. A nonionic surfactant includes, for example, ethoxylated fatty acids, alcohol ethoxylates, tristyrylphenol ethoxylates, ethoxylated sorbitan fatty acid esters, and mixtures thereof. In a further embodiment, a nonionic surfactant is ethoxylated fatty acids. In yet a further embodiment, the ethoxylated fatty acids is castor oil ethoxylates.

The invention further provides compositions including between 0.1% and 95% by weight of the cyclohexanedione oxime or an agriculturally acceptable salt or metal complex thereof. In one embodiment, a composition includes between 0.1% and 15% by weight of the stabilizer. In another embodiment, a composition includes between 0.1 to about 30% by weight of the surfactant.

In certain embodiments, a cyclohexanedione oxime or agriculturally acceptable salt thereof is selected from methyl(E)-(RS)-3-[1-(alloxyimino)butyl]-4-hydroxy-6,6-dimethyl-2-oxocyclohex-3-enecarboxy-late), 5-(3-butyryl-2,4,6-trimethylphenyl)-2-(1-ethoxyiminopropyl)-3-hydroxycyclohex-2-enone), (2-{1-[2-(4-chlorophenoxy)propoxyimino]butyl}-3-hydroxy-5-thian-3-ylcyclohex-2-enone), (±)-2-[(E)-1-[(E)-3-chloroallyloxyimino]propyl]-5-[2-(ethylthio)propyl]-3-hydroxycyclohex-2-enone), (±)-2-[1-(ethoxyimino)butyl]-3-hydroxy-5-thian-3-ylcyclohex-2-enone), (±)-(EZ)-2-(1-ethoxyiminobutyl)-5-[2-(ethylthio)propyl]-3-hydroxycyclohex-2-enone), (EZ)-(RS)-2-{1-[(2E)-3-chloroallyloxy-imino]propyl}-3-hydroxy-5-perhydropyran-4-ylcyclohex-2-en-1-one), 2-[1-(ethoxyimino)propyl]-3-hydroxy-5-mesitylcyclohex-2-enone), and 2-[1-[[2-(4-chlorophenoxy)propoxy]imino]butyl]-3-hydroxy-5-(tetrahydro-2H-thiopyran-3-yl)-2-cyclohexen-1-one. In one embodiment, the cyclohexanedione oxime or agriculturally acceptable salt thereof comprises (±)-2-[(E)-1-[(E)-3-chloroallyloxyimino]propyl]-5-[2-(ethylthio)propyl]-3-hydroxycyclohex-2-enone), or a salt thereof. In a particular embodiment, a composition comprises an emulsifiable concentrate, wettable powder, granule, pellet, dust, oil or aerosol.

The invention also provides methods of controlling weeds. In one embodiment, a method includes applying a composition including a cyclohexanedione oxime or an agriculturally acceptable salt thereof, and an effective amount of a stabilizer including an epoxidized oil fatty acid or an epoxidized ester of a fatty acid to a weed, a crop, or an habitat area. Compositions applicable in the methods may further include additional components, such as a diluent and one or more adjuvants.

In particular embodiments, a method includes applying a composition including a cyclohexanedione oxime or agriculturally acceptable salt thereof selected from methyl(E)-(RS)-3-[1-(alloxyimino)butyl]-4-hydroxy-6,6-dimethyl-2-oxocyclohex-3-enecarboxy-late), 5-(3-butyryl-2,4,6-trimethylphenyl)-2-(1-ethoxyiminopropyl)-3-hydroxycyclohex-2-enone), (2-{1-[2-(4-chlorophenoxy)propoxyimino]butyl}-3-hydroxy-5-thian-3-ylcyclohex-2-enone), (±)-2-[(E)-1-[(E)-3-chloroallyloxyimino]propyl]-5-[2-(ethylthio)propyl]-3-hydroxycyclohex-2-enone), (±)-2-[1-(ethoxyimino)butyl]-3-hydroxy-5-thian-3-ylcyclohex-2-enone), (±)-(EZ)-2-(1-ethoxyiminobutyl)-5-[2-(ethylthio)propyl]-3-hydroxycyclohex-2-enone), (EZ)-(RS)-2-{1-[(2E)-3-chloroallyloxy-imino]propyl}-3-hydroxy-5-perhydropyran-4-ylcyclo-hex-2-en-1-one), 2-[-(ethoxyimino)propyl]-3-hydroxy-5-mesitylcyclohex-2-enone), and 2-[1-[[2-(4-chlorophenoxy)propoxy]imino]butyl]-3-hydroxy-5-(tetrahydro-2H-thiopyran-3-yl)-2-cyclohexen-1-one In a particular embodiment, a method includes applying a composition including (±)-2-[(E)-1-[(E)-3-chloroallyloxyimino]propyl]-5-[2-(ethylthio)propyl]-3-hydroxycyclohex-2-enone), or a salt thereof.

Methods of the invention include control of a weed, such as a grass plant. In certain embodiments, the grass plant is selected from the group consisting of Barley, Barnyard grass, Bermudagrass, Broadleaf Signalgrass, Bromes, Corn, Crabgrasses, Crowfootgrass, Fall Panicum, Fescue, Foxtail Barley, Foxtails, Green foxtail, Goosegrass, Grain Sorghum, Itchgrass, Junglerice, Large Crabgrass, Lovegrass, Oats, Orchardgrass, Perennial grasses, Quackgrass, Persian Darnel, Proso Millet, Red Rice, Rhizome Johnsongrass, Rye, Rygrasses, Seedling Johnsongrass, Shattercane, Smooth Crabgrass, Southwestern Cupgrass, Sprangetops, Texas Panicum, Volunteer Barley, Volunteer Oats, Volunteer Corn, Volunteer Canary Seed, Volunteer Wheat, Wheat, Wild Oats, Wild Proso Millet, Witchgrass, Woolly Cupgrass, Wirestem Muhly, and Yellow Foxtail.

A composition can be applied as a post-emergence or pre-emergence treatment. In one embodiment, a composition is applied to a crop plant in need of weed control or at risk of undesirable weeds. Such a crop plant can be, for example, any of canola, flax, peas, lentils, beans, linola, mustard, chickpeas, sunflowers, potatoes, seedling alfalfa, onions, and soybeans.

The invention also provides methods for producing a stabilized herbicidal composition. In one embodiment, a method includes mixing a cyclohexanedione oxime with one or more stabilizers thereby producing a stabilized herbicidalcomposition. In another embodiments, a method includes (a) mixing one or more stabilizers with a diluent to form a first mixture; (b) adding one or more adjuvants to the first mixture to form a second mixture; and (c) adding a cyclohexanedione oxime to the second mixture, thereby producing a stabilized herbicidal composition.

### DETAILED DESCRIPTION OF THE INVENTION

The invention provides, inter alia, stabilized herbicide compositions. In one embodiment, a composition includes a herbicidal cyclohexanedione oxime or an agriculturally acceptable salt thereof, and an effective amount of a stabilizer comprising an epoxidized oil fatty acid or an epoxidized ester of a fatty acid.

In various aspects, an herbicidal cyclohexanedione oxime or an agriculturally acceptable salt thereof is selected from the group consisting of Alloxydim (methyl(E)-(RS)-3-[1-(alloxyimino)butyl]-4-hydroxy-6,6-dimethyl-2-oxocyclohex-3-enecarboxy-late), or a salt, Butroxydim (5-(3-butyryl-2,4,6-trimethylphenyl)-2-(1-ethoxyiminopropyl)-3-hydroxycyclohex-2-enone), or a salt, Clefoxydim also known as BAS 625H (2-{1-[2-(4-Chlorophenoxy)propoxyimino]butyl}-3-hydroxy-5-thian-3-ylcyclohex-2-enone), or a salt, Clethodim ((±)-2-[(E)-1-[(E)-3-Chloroallyloxyimino]propyl]-5-[2-(ethylthio)propyl]-3-hydroxycyclohex-2-enone), or a salt, Cycloxydim((±)-2-[1-(ethoxyimino)butyl]-3-hydroxy-5-thian-3-ylcyclohex-2-enone), or a salt, Profoxydim 2-[1-[[2-(4-chlorophenoxy)propoxy]imino]butyl]-3-hydroxy-5-(tetrahydro-2H-thiopyran-3-yl)-2-cyclohexen-1-one, or a salt, Sethoxydim ((±)-(EZ)-2-(1-ethoxyiminobutyl)-5-[2-(ethylthio)propyl]-3-hydroxycyclohex-2-enone), or a salt, Tepraloxydim ((EZ)-(RS)-2-{1-[(2E)-3-Chloroallyloxy-imino]propyl}-3-hydroxy-5-perhydropyran-4-ylcyclo-hex-2-en-1-one), or a salt, and Tralkoxydim (2-[1-(ethoxyimino)propyl]-3-hydroxy-5-mesitylcyclohex-2-enone), or a salt thereof.

Cyclohexanedione oximes are commercially available. For example, Clethodim is provided by Valent U.S.A. Corporation and Arysta LifeScience North America, Sethoxydim and Alloxydim are produced by Nippon Soda Company or BASF Corporation, Cycloxydim and Profoxydim are produced by BASF Corporation, and Butroxydim is produced by CropCare Australia.

The concentration of cyclohexanedione oxime in the formulation can be expressed in the units of percentage or grams/liter. The percentage, by weight (or “weight percent”), of a cyclohexanedione oxime in the formulation of the invention can vary. In certain embodiments, the percentage by weight of a cyclohexanedione oxime in the formulation is between 0.1% and 95%. In other embodiments, the percentage by weight of a cyclohexanedione oxime in the fonnulation is between 0.5% and 90%. In additional embodiments, the percentage by weight of a cyclohexanedione oxime in the formulation is between 10% and 70%. In further embodiments, the percentage by weight of the cyclohexanedione oximes in the formulation is between 10% and 25%. In still other embodiments, the percentage by weight of a cyclohexanedione oxime in the formulation is between 26% and 40%. In still further embodiments, the percentage by weight of a cyclohexanedione oxime in the formulation is between 41% and 60%. In still further embodiments, the percentage by weight of the cyclohexanedione oximes in the formulation is between 61% and 90%. Similarly, the grams/liter of a cyclohexanedione oxime in the formulation of the invention may range from 20 g/L to 800 g/L, or from 100 g/L to 400 g/L.

The epoxidized oil or ester include and can be derived from animal or vegetable fatty acids. Non limiting examples of animal fatty acids include butter, lard, tallow, grease, herring, menhaden, pilchard, sardine, and babassu. Non limiting examples of plant fatty acids include castor, coconut, corn, cottonseed, jojoba, linseed, oiticica, olive, palm, palm kernel, peanut, rapeseed, safflower, soya, sunflower, tall, and tung. Common epoxidized vegetable oil fatty acids and esters include and can be derived from soybean and linseed oils. Specific non-limiting examples of epoxidized oils are PARAPLEX® G-60 (epoxidized soybean oil) and PARAPLEX® G-62 (epoxidized soybean oil) manufactured by the Hallstar Company (120 S. Riverside Plaza, Suite 1620, Chicago, Ill.).

Suitable epoxidized esters of fatty acids include, for example, monoesters and diesters of fatty acids. Examples of glycols from which a suitable ester can be derived from include, but are not limited to, propylene glycol, dipropylene glycol, ethylene glycol and diethylene glycol.

Fatty acids derived from vegetable oils include fatty acids containing carbon chains of about 2 to about 24 carbons, about 12 to about 24 carbons, or about 16 to about 18 carbons. The fatty acid may be unsaturated. The one or more sites of unsaturation can be epoxidized by methods known in the art. Fatty acid chains can have one or more oxirane rings. Thus, a fatty acid that has multiple sites of unsaturation can be epoxidized to a greater extent (i.e. have 2, 3, 4, 5, 6, or more epoxides at any position). However, not all double bonds of the fatty acid chain must be epoxidized. A fatty acid chain containing one oxirane ring formed between two adjacent carbons of the carbon chain is a fatty acid from which a suitable ester can be derived. Fatty acids with multiple sites of unsaturation can have one or more double bonds so long as at least one oxirane ring is embedded in adjacent carbons as described above. A fatty acid may contain one or more epoxides (or epoxide groups). The epoxides can be located at any position on the fatty acid carbon chain. For example, an epoxide can be located at C-9 (i.e. 9,10-epoxide) or at C-12 (i.e. 12,13-epoxide) of a fatty acid carbon chain. Specific non-limiting examples of fatty acids include, but are not limited to, palmitic acid (hexadecanoic acid), palmitoleic acid (9-hexadecenoic acid), stearic acid (octadecanoic acid), oleic acid (9-octadecenoic acid), ricinoleic acid (12-hydroxy-9-octadecenoic acid), vaccenic acid (11-octadecenoic acid), linoleic acid (9,12-octadecadienoic acid), alpha-linolenic acid (9,12,15-octadecatrienoic acid), gamma-linolenic acid (6,9,12-octadecatrienoic acid), arachidic acid (eicosanoic acid), gadoleic acid (9-eicosenoic acid), arachidonic acid (5,8,11,14-eicosatetraenoic acid), and erucic acid (13-docosenoic acid).

The term “epoxide” used herein refers to three membered cyclic ether (also called an oxirane or or alkylene oxide) in which an oxygen atom is joined to each of two carbon atoms that are bonded to each other. Epoxides undergo reactions such as C—O bond cleavage, nucleophilic addition, hydrolysis and reduction under mild conditions and more rapidly than other ethers. Epoxides are formed by some oxidation reactions of alkenes with peracids. The epoxy functionality is believed to contribute to stability (e.g., against heat and light).

In certain embodiments, a stabilizer is a propylene glycol monoester, methyl ester or allyl ester of an oil fatty acid. In additional embodiments, a stabilizer is 9-octadecenoic acid (Z)-, epoxidized, ester with propylene glycol. In further embodiments, a stabilizer is fatty acid, soya, epoxidized, or 2-ethylhexyl ester.

The percentage by weight of the stabilizer in a formulation of the invention can be between about 0.1% and 15%, between about 1% and 10%, or between about 1% and 5%. Typically the amount of a stabilizer, (e.g. by weight) will be less than the amount of an herbicidal active ingredient. However, the amount may be determined based upon a particular stabilizer and active ingredient, optionally in combination with other ingredients, such as solvent/diluent and adjuvants. Typically, a formulation having from 3% to 8% of adjuvant may comprise from 1% to 5% stabilizer; a fonnulation having from 8% to 16% of adjuvant may comprise from 1% to 10% of stabilizer; and a formulation having from 17% to 30% adjuvant may comprise from 1% to 15% stabilizer.

As used herein, the tenns “stabilization” or “stabilized,” refers to a herbicidal composition with increased chemical and/or physical stability, or reduced degradation, as compared to an unstabilized herbicidal composition. The extent of stabilization can be measured by activity of an herbicide, or the amount of active (un-degraded) herbicide. For example, a stabilized herbicide will exhibit greater activity against one or more weeds than unstabilized herbicide after a period of time in storage, exposed to heat, light, moisture (water) or other conditions that result in a reduction of activity by degradation of the herbicide. In certain embodiments, a cyclohexanedione oxime contained in a formulation of the invention will degrade by no more than about 25% within a period of 24 months. In other embodiments, a cyclohexanedione oxime contained in a fonnulation of the invention will degrade by no more than about 15% within a period of 24 months. In further embodiments, a cyclohexanedione oxime contained in a formulation of the invention will degrade by no more than about 10% within a period of 24 months. In still other embodiments, a cyclohexanedione oxime contained in a formulation of the invention will degrade by no more than about 6% within a period of 24 months. In additional embodiments, a cyclohexanedione oxime contained in a formulation of the invention will degrade by no more than about 3% within a period of 24 months.

As used herein, the term “effective amount” when used in reference to a stabilizer, is an amount of stabilizer necessary to inhibit, reduce or prevent degradation of an active ingredient (e.g. herbicide) in the composition due to one or more external environmental effects, for example, exposure to sunlight (UV), moisture (e.g. humidity, water), and heat. Typically, an effective amount of stabilizer will prevent the active ingredient from degrading of no more than 25% due to exposure of UV, moisture, or heat within a long period of time, say, a two-year period. In other embodiment, an effective amount of stabilizer will prevent the active ingredient from degrading of no more than 15% due to exposure of UV, moisture (e.g. humidity, water), or heat within a two-year period.

Formulations of the invention can include one or more solvents. The amount of solvents in a formulation may range from 1% to 99%, or from 30% to 80%. Suitable solvents include, for example, a non-polar water-immiscible solvent, or a polar aprotic water miscible organic solvent. Non-polar solvents include, for example, substituted or unsubstituted aliphatic or aromatic hydrocarbons and esters of plant oils or mixtures thereof. Non-limiting examples of aromatic hydrocarbons include benzene or substituted benzene derivatives such as toluene, xylene, 1,2,4-trimethylbenzene, naphthalene or mixtures thereof. In one embodiment, a solvent includes a mixture of napthalen and 1,2,4-trimethylbenzene. In a another embodiment, a solvent is Aromatic 150, a heavy aromatic naptha solvent containing <10% naphthalene and <1.7% 1,2,4-trimethylbenzene.

Alkyl esters can also be used as non-polar, water immiscible solvents. Plant oils may be esterified with various alcohols to form alkyl esters of plant oils. Fatty acids of these plant oils have 5 to 20, or 6 to 15 carbon atoms. Alkyl esters of plant oils include, without limitation, methyl, ethyl and butyl esters of canola (B. napus), linseed, safflower (Carthamus tinctorius L.), soybean and sunflower oils. In one embodiment, the solvent is a mixture of methyl esters. A specific non-limiting example of methyl esters is Agent 2416-21 manufactured by Stepan Company (22 W. Frontage Road, Northfield, Ill.).

Water-miscible polar aprotic solvents include, for example, alkyl lactates, isopropyl lactate, alkyl carbonates, polyethylene glycols, polyethylene glycol alkyl ethers, polypropylene glycols, and polypropylene glycol alkyl ethers, or mixtures thereof.

The composition may include one or more adjuvants. An adjuvant may enhance or improve herbicidal performance, for example. Adjuvants may be added to the composition at the time of formulation, or by the applicator to a mix prior to treatment. Adjuvants include, for example, surfactants (emulsifier), crop oil, fertilizers, dispersing agents, compatibility agents, foaming activators, foam suppressants, correctives, and spray colorants (dyes). An adjuvant may be present in any desired amount. For example, a formulation may contain 1% to 3% adjuvant, 3% to 8% of adjuvant, 8% to 16% adjuvant, 17% to 30% adjuvant, or 30% or (e.g. 40% or more) more adjuvant.

A surfactant may increase solubility of an active ingredient in a solution. A surfactant may also affect spray retention, droplet spreading, and dry rates. A surfactant may be anionic or nonionic. Examples of anionic surfactants include phosphoric mono- and di-esters of long-chain alcohols having 14 to 22 carbon atoms and the salts thereof; phosphoric mono- and di-esters of alkylene oxide addition products of long-chain alcohols having 14 to 22 carbon atoms and the salts thereof; alkylsulfates having 14 to 22 carbon atoms; polyoxyethylene alkyl ether sulfates of alcohols having 14 to 22 carbon atoms; alkane sulfonates having 14 to 22 carbon atoms; and olefin sulfonates having 14 to 22 carbon atoms.

Suitable non-ionic surfactants include, for example, ethoxylated fatty acids, alcohol ethoxylates, tristyrylphenol ethoxylates, ethoxylated sorbitan fatty acid esters or mixtures thereof. Ethoxylated fatty acids include castor or canola oil ethoxylates having at least 25, preferably 27 to 37 ethoxy units, such as Sunaptol® CA350 (castor oil ethoxylate with 35 ethoxy units) of Uniqema (formerly ICI Surfactants), Mergital® EL33 (castor oil ethoxylate with 33 ethoxy units) of Henkel KGaA, Eumulgin® C03373 (canola oil ethoxylate with 30 ethoxy units) of Henkel KGaA and Ukanil® 2507 (castor oil ethoxylate) of Uniqema.

Surfactants may be present in any desired amount. For example, a surfactant may be present in an amount of about 0.1 to about 30% by weight in the formulation. In a particular embodiment, a surfactant is present in an amount of about 1 to about 9% by weight in the formulation. In another embodiment, a surfactant is present in an amount of about 10 to about 20% by weight in the formulation.

An emulsifier is a type of surfactant typically used to keep emulsion well dispersed. Non-limiting examples of the emulsifier include Agent 2201-76, Agent 2416-20, Emulpon CO-360, T-Det C-40®, and Agnique™ SBO-10. Agent 2201-76 is manufactured by Stepan Company (22 W. Frontage Road, Northfield, Ill.), which is a blend of nonionic and anionic surfactants (82%). The ingredients in Agent 2201-76 are alkylbenzene sulfonate and fatty acid ethoxylate, aromatic petroleum hydrocarbon, 1-hexanol and naphthalene. Agent 2416-20 is also manufactured by Stepan Company (22 W. Frontage Road, Northfield, Ill.), which is a blend of nonionic and anionic surfactants (35-37%). Agent 2416-20 also includes aromatic petroleum hydrocarbon (57-58%), and naphthalene (6-7%). Emulpon CO-360 is manufactured by Akzo Nobel Chemicals Ltd. (525 West Van Buren, Chicago, Ill.), which contains ethoxylated castor oil (100% by weight) and oxirane (<0.001% by weight). T-Det C-40® may be purchased from Harcros Organics (5200 Speaker Road., P.O. Box 2930, Kansas City, Kans.), or from Akzo Nobel Chemicals Ltd. (525 West Van Buren, Chicago, Ill.), which is a non-ionic emulsifier, and a brand of ethoxylated (polyethoxylated) castor oil. Agnique™ SBO-10 is manufactured by Cognix GmbH headquartered in Monheim, Germany, which contains alkoxylated triglycerides as an ethoxylated soybean oil.

A crop oil, or a crop oil concentrate, may be used to increase the efficacy of a herbicide formulation. Although not wishing to be bond by any particular theory, a crop oil is believed to keep the leaf surface moist longer than water, which in turn allows more time for the herbicide to penetrate, thereby increasing the amount of herbicide that will enter the plant (e.g. weed). A crop oil can improve uptake of herbicide by plant (e.g. weed). A crop oil can therefore improve, enhance, increase or promote herbicidal efficacy or activity. Crop oils may contained from 1% to 40% by weight, or 1% to 20% by weight in the formulation. A crop oil can be derived from either petroleum oil or vegetable oil. Non-limiting examples of crop oil include soybean oils and petroleum based oils.

The herbicidal compositions can be in customary formulations. Non-limiting examples include solutions, emulsions, suspensions, wettable powders, powders, dusts, pastes, soluble powders, granules, pellets, emulsifiable concentrate, oil spray, aerosol, natural and synthetic materials impregnated with active compound, and very fine capsules (e.g. in polymeric substances). In certain embodiments, the composition is in a form of an emulsifiable concentrate, wettable powder, granule, (lust, oil spray or aerosol.

The formulations may optionally include adherent coatings. Such coatings include those that aid the active ingredient to adhere to the intended environment, for example, a weed. Adherent coatings include carboxymethylcellulose, natural and synthetic polymers in various forms, such as powders, granules or latexes. Other adherent coatings include gum arabic, polyvinyl alcohol and polyvinyl acetate. Phospholipids, such as cephalins and lecithins, and synthetic phospholipids are also examples of adherent coatings. Further additives may be mineral and vegetable oils.

Colourants can also be included in the formulations. Non-limiting examples are inorganic pigments, such as iron oxide, titanium oxide and Prussian Blue, and organic dyestuffs, such as alizarin dyestuffs, azo dye-stuffs and metal phthalocyanine dyestuffs, and trace nutrients such as salts of iron, manganese, boron, copper, cobalt, molybdenum and zinc.

Herbicidal compositions according to the invention can be applied in the form of ready mixes. Herbicidal compositions can also be formulated individually and mixed upon use, i.e. applied in the form of tank mixes.

Herbicidal compositions of the invention can be used as such or in the form of their formulations, and furthermore also as mixtures with other herbicides, ready mixes or tank mixes. Herbicidal compositions may also be mixed with other active compounds, such as fungicides, insecticides, acaricides, nematicides, bird repellents, growth substances, plant nutrients and agents which improve soil structure. For particular application purposes, in particular when applied post-emergence, formulations such as mineral or vegetable oils which are tolerated by plants (for example the commercial product “Oleo DuPont 11E”) or ammonium salts such as, for example, ammonium sulphate or ammonium thiocyanate, as further additives can be included.

Herbicidal compositions of the invention may also exclude any of the aforementioned. For example, other herbicides, fungicides, insecticides, acaricides, nematicides, bird repellents, growth substances, plant nutrients and agents which improve soil structure can be excluded or omitted from a composition of the invention.

Herbicidal compositions can be used as such, in the form of their formulations or in the forms prepared therefrom by dilution of a concentrated form, such as ready-to-use or concentrated liquids, solutions, suspensions, emulsions, or solids, such as, powders, pastes, granules and pellets. They are dispersed in the customary manner, for example by watering, spraying, atomizing, dusting or scattering.

Formulations of the invention can be produced by mixing or suspending one or more stabilizers, an active ingredient, and optionally an adjuvant, a diluent or a solvent. In certain embodiments, formulations of the invention can be produced, for example by first mixing or suspending one or more stabilizers with a diluent or solvent. Next, the appropriate amount of adjuvants is combined to the resulting mixture containing the stabilizers. An active ingredient, cyclohexanedione oxime, can added at the end and blended until the formulation becomes mostly or entirely homogeneous.

In one embodiment, a method for producing a stabilized herbicidal composition includes mixing a cyclohexanedione oxime with one or more stabilizers thereby producing a stabilized composition. In another embodiment, a method comprises a) mixing one or more stabilizers with a diluent to form a first mixture; b) adding one or more adjuvants to the first mixture to form a second mixture; and c) adding a cyclohexanedione oxime to the second mixture, thereby producing a stabilized composition.

Desirable plants are generally referred to herein as “crop plants.” The term “crop plants” as used herein, includes any edible or non-edible plant, including decorative, plant species with commercial value, which is planted and cultivated for commercial use. Thus, crop plants include floral and non-floral plants, trees, vegetable plants, turf, and ground cover. Non-limiting specific examples of crop plants include canola, flax, peas, lentils, beans, linola, mustard, chickpeas, sunflowers, potatoes, seedling alfalfa, onions, soybeans and turf grass. The term “plants” is meant to include germinant seeds, emerging seedlings, and established vegetation, including roots and above-ground portions (for example, leaves, stalks, flowers, fruits, branches, limbs, root, etc.).

The term “turf” used herein refers to grass which grow in areas in which they are desired, or purposely planned for and maintained, for example, a lawn. Turf also refers to a sod, where the surface layer of ground consisting of a mat of grass and grass roots.

Compositions of the invention include active herbicides against one or more species of weeds. In the broadest sense, the term “weed” refers to plants which grow in locations in which they are not desired. In other words, a weed is a plant in which in the context of a crop is undesirable due to competition for water, nutrients, sunlight, soil, etc. A grass plant is one example of weeds.

Weeds can be controlled using the compositions of the invention. The invention therefore provides methods for controlling weeds. In one embodiment, a method includes applying (contacting) a composition comprising a cyclohexanedione oxime or agriculturally acceptable salt thereof, and an effective amount of a stabilizer comprising an epoxidized oil fatty acid or an epoxidized ester of a fatty acid to a weed, a crop or a plant habitat or area. Such methods are applicable to a plant including, but not limited to, one or more weeds described herein.

Herbicidal compositions of the invention can be applied before the weed has emerged (pre-emergence) or after the weed has emerged (post-emergence). They can be applied to all or a part of a weed, a crop or habitat area.

A weed can be a green plant, or a grass weed. The grass plant to be controlled is in a pre-emergent or post-emergent growth stage at the time of applying (contact) of a herbicidal composition.

In methods of the invention, “control” and “controlling” includes any adverse modifying or detrimental effect that includes any deviation from natural plant survival, growth or development. Specific non-limiting examples include inhibiting, reducing, or preventing growth of all or any part of a weed (root, stem, stalk, leaf, flower, branch, etc.), weed germination, weed maturation, weed spreading, or killing the weed.

Methods of the invention can be used to control one or more grasses. Examples of grass plant species against which the compositions and methods of the invention can be used include, but are not limited to, the following: Barley (Hordeum vulgare), Barnyard grass (Echinochloa crus-galli), Bermudagrass (Cynodon dactylon), Broadleaf Signalgrass (Brachiaria platphylla), Bromes (Bromus species), Corn (Zea mays), Crabgrasses (Digitaria species), Crowfootgrass (Dactyloctenium aegyptium), Fall Panicum (Panicum dichotomiflorum), Fescue (Festuca arundinacea), Foxtail Barley (Hordeum jubatum), Foxtails (Setaria species), Green Foxtail, Goosegrass (Eleusine indica), Grain Sorghum (Sorghum bicolor), Itchgrass (Rottboellia exaltata), Junglerice (Echinochloa colona), Large Crabgrass, Lovegrass (Eragrostis cilanensis), Oats (Avena sativa), Orchardgrass (Dactylis glomerata), Perennial grasses, Quackgrass (Agropyron repens), Persian Darnel, Proso Millet, Red Rice (Oryza sativa), Rhizome Johnsongrass (Sorghum halepense), Rye (Secale cereale), Rygrasses (Lolium species), Seedling Johnsongrass (Sorghum halepense), Shattercane (Sorghum bicolor), Smooth Crabgrass, Southwestern Cupgrass (Eriochlola gracillis), Sprangetops (Leptochloa species), Texas Panicum (Panicum texanum), Volunteer Barley, Volunteer Oats, Volunteer Corn, Volunteer Canary Seed, Volunteer Wheat, Wheat (Triticum aestivum), Wild Oats (Avena fatua), Wild Proso Millet (Panicum miliaceum), Witchgrass (Panicum capillare), Woolly Cupgrass (Eriochloa villosa), Wirestem Muhly (Muhlenbergia frondisa), and Yellow Foxtail.

The application rate varies depending, for example, on the crop or the targeted weed. In general, the application rate is from 0.01 kg/ha to 5.00 kg/ha or from 0.03 kg/ha to 3.00 kg/ha of the active ingredient.

The terms “composition” and “formulation” as used herein are interchangeable.

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described herein.

All applications, publications, patents and other references, citations cited herein are incorporated by reference in their entirety. In case of conflict, the specification, including definitions, will control.

As used herein, the singular forms “a”, “and,” and “the” include plural referents unless the context clearly indicates otherwise.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. Reference to a range of 90-100% includes 92.2% to 97.5%, 91.5 to 94.5, etc. Reference to a series of ranges, such as, overlapping ranges between 0.1% and 15%, and between 1% and 10%, include ranges between 0.1% and 1%, 0.1% and 10%, 1% and 15%, and 10% and 15%.

The invention is generally disclosed herein using affirmative language to describe the numerous embodiments. The invention also specifically includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein.

A number of embodiments of the invention have been described. Nevertheless, it will be understood that various modifications may be made without departing from the spirit and scope of the invention. Accordingly, the following examples are intended to illustrate but not limit the scope of invention described in the claims.

To illustrate the invention, specific examples are set forth below. These examples are merely illustrations and are not to be understood as limiting the scope and underlying principles of the invention in any way. Various modifications of the invention in addition to those shown and described herein will become apparent to those skilled in the art form the following examples and foregoing description. Such modifications are also intended to fall within the scope of the appended claims.

### Examples

In the following examples, exemplary herbicidal formulations of the invention and other control herbicidal formulations are studied for their storage stabilities. In many cases, comparisons are made to similar commercially available herbicidal formulations which contain clethodim as the active ingredient.

One such commercially available herbicidal formulation used for comparison purpose is Arysta Select 1E, a product of Arysta LifeScience North America Corporation. Another conunercially available herbicidal formulation used for comparison purposes is Valent Select Max™, a product of Valent U.S.A. Corporation. Another commercially available herbicidal formulation used for comparison purposes is Helena Clethodim 1E, a product of Helena Chemical Company.

Several exemplary herbicidal formulations of the invention were prepared and/or studied in the following examples. These herbicidal formulations are composed of the following constituents:

### Formulation A

| Formulation A-1 | |
|---|---|
| Clethodim 70% Multi-use product (MUP) | 20.43% |
| Aromatic 150 (solvent) | 76.57% |
| Agent 2201-76 (emulsifier) | 3.00% |
| Formulation A-3 | |
| Clethodim 70% MUP | 20.43% |
| Aromatic 150 (solvent) | 73.57% |
| Agent 2201-76 (emulsifier) | 3.00% |
| Paraplex G-62 | 3.00% |
| Formulation A-4 | |
| Clethodim 70% MUP | 20.43% |
| Agent 2416-21(solvent) | 59.57% |
| Emulpon CO-360 (emulsifier) | 5.00% |
| Paraplex G-62 | 15.00% |
| Formulation A-5 | |
| Clethodim 70% MUP | 20.43% |
| Aromatic 150 (solvent) | 68.57% |
| Agent 2201-76 (emulsifier) | 3.00% |
| Agnique SBO-10 | 5.00% |
| Paraplex G-62 | 3.00% |
| Formulation A-6 | |
| Clethodim 70% MUP | 20.43% |
| Aromatic 150 (solvent) | 70.57% |
| Agent 2201-76 (emulsifier) | 3.00% |
| Agnique SBO-10 | 3.00% |
| Paraplex G-62 | 3.00% |

### Formulation B

| Formulation B-1 | |
|---|---|
| Clethodim 70% MUP | 37.70% |
| Aromatic 150 (solvent) | 59.30% |
| Agent 2201-76 (emulsifier) | 3.00% |
| Formulation B-2 | |
| Clethodim 70% MUP | 37.70% |
| Aromatic 150 (solvent) | 56.30% |
| Agent 2201-76 (emulsifier) | 3.00% |
| Paraplex G-60 | 3.00% |
| Formulation B-3 | |
| Clethodim 70% MUP | 37.70% |
| Aromatic 150 (solvent) | 56.30% |
| Agent 2201-76 (emulsifier) | 3.00% |
| Paraplex G-62 | 3.00% |

### Formulation C

| Formulation C-1 | |
|---|---|
| Clethodim 70% MUP | 52.90% |
| Aromatic 150 (solvent) | 44.10% |
| Agent 2201-76 (emulsifier) | 3.00% |
| Formulation C-2 | |
| Clethodim 70% MUP | 52.90% |
| Aromatic 150 (solvent) | 41.10% |
| Agent 2201-76 (emulsifier) | 3.00% |
| Paraplex G-60 | 3.00% |
| Formulation C-3 | |
| Clethodim 70% MUP | 52.90% |
| Aromatic 150 (solvent) | 41.10% |
| Agent 2201-76 (emulsifier) | 3.00% |
| Paraplex G-62 | 3.00% |

### Formulation D

| Formulation D-1 | |
|---|---|
| Clethodim 94% MUP | 15.20% |
| Aromatic 150 (solvent) | 5.23% |
| Agent 2416-21 (solvent) | 52.20% |
| Agent 2416-20 (surfactant) | 27.37% |
| Formulation D-2 | |
| Clethodim 94% MUP | 15.20% |
| Agent 2416-21 (solvent) | 66.80% |
| T-Det C40 (emulsifier) | 5.00% |
| Agnique SBO-10 | 10.00% |
| Paraplex G-62 | 3.00% |
| Arysta Select ® | |
| Clethodim 70% MUP | 25% |
| Petroleum solvent containing: | 75% |
| Naphthalene | |
| Trimethylbenzene | |
| Valent Select Max ™ | |
| Clethodim | 12.6% |
| Other ingredients | 87.4% |

Helena Clethodim 1E, lot 06238-GV-A

### Example 1

### Evaluation of Stability of Stabilized Clethodim Formulations (14-Day Period).

Formulations A-C described above were subjected to a stability test at 50° C. for two years. The formulations were stored at 50° C.±2° C. and evaluated at 2, 7 and 14 days. The percent by weight of the active ingredient, clethodim, was determined at each time interval by High Performance Liquid Chromatography (HPLC) analysis. HPLC analysis was conducted under the following conditions:

Instrumentation
Mettler AE 200 analytical balance, S/N P49480
Liquid Chromatograph, Shimadzu LC-2010A HT, S/N C21244404636LP
Luna C-18 (2), (150 mm×4.6 mm, 5 μm) i.d., SN 461773-5
Volumetric glassware, class A
Sonicator, VWR Scientific

HPLC Parameters
Mobile phase: 65% Acetonitrile, 35% buffered HPLC water buffered w/acetic acid (pH=3.0), (v/v)
Flow rate: 1.5 mL/min
Injection volume: 10 ul
Running time: 15 minutes
Dectector: UV absorption at 270 nm

The percent active ingredient (% AI) and remaining percentages of clethodim are illustrated in Table 1. The remaining percentages are calculated as compared to the initial amount of clethodim present according to the zero day analysis.

TABLE 1
Stability of formulations containing clethodim (14-day period).

| | Initial | 2 days | | 7 days | | 14 days | |
|---|---|---|---|---|---|---|---|
| | % | | % | | % | | % |
| Formulation | AI | % AI | changes | % AI | changes | % AI | changes |
| Formulation | 35.42 | 34.33 | 96.92 | 34.21 | 96.58 | 33.69 | 95.12 |
| C-3 | | | | | | | |
| Formulation | 25.16 | 24.64 | 97.93 | 24.28 | 96.50 | 24.24 | 96.34 |
| B-3 | | | | | | | |
| Formulation | 13.12 | 13.53 | 103.13 | 13.52 | 103.05 | 13.46 | 102.59 |
| A-5 | | | | | | | |
| Formulation | 13.87 | 13.65 | 98.41 | 13.55 | 97.69 | 13.60 | 98.05 |
| A-6 | | | | | | | |

### Example 2

### Evaluation of Stability of Stabilized Clethodim Formulations (24-Month Period).

Formulations A-C described above were subjected to a stability test at 54° C. for two weeks, simulating two years. For comparison purposes, commercially available herbicidal clethodim formulations containing no stabilizer were also studied. The formulations were stored at 54° C. ±2° C. and evaluated at 0, 7 and 14 days, the results were extrapolated out to simulate 8, 16 and 24 months for direct comparison to other accelerated studies. The percent by weight of the active ingredient, clethodim, was determined at each time interval by High Performance Liquid Chromatography (HPLC) analysis. HPLC analysis was conducted under the following conditions:

Instrumentation
Mettler AE 200 analytical balance, S/N P49480
Liquid Chromatograph, Shimadzu LC-2010A HT, S/N C21244404636LP
Luna C-18 (2), (150 mm×4.6 mm, 5 μm) i.d., SN 461773-5
Volumetric glassware, class A
Sonicator, VWR Scientific

HPLC Parameters
Mobile phase: Acetonitrile/HPLC Water buffered w/acetic acid (65135) (v/v)
Flow rate: 1.5 mL/min
Injection volume: 10 ul
Running time: 15 minutes
Dectector: UV absorption at 270 nm

The percent active ingredient (% AI) and remaining percentages of clethodim are illustrated in Table 1. The remaining percentages are calculated as compared to the initial amount of clethodim present according to the zero day analysis.

TABLE 2
Stability of formulations containing clethodim (24-month period).

| | | 8 months | | 16 months | | 24 months | |
|---|---|---|---|---|---|---|---|
| | Initial | | % | | % | | % |
| Formulation | % AI | % AI | changes | % AI | changes | % AI | changes |
| Formulation | 13.25 | 12.85 | 96.98 | 12.65 | 95.47 | 11.65 | 87.92 |
| A-1 | | | | | | | |
| Formulation | 13.61 | 13.53 | 99.41 | 13.51 | 99.27 | 13.46 | 98.90 |
| A-3 | | | | | | | |
| Formulation | 13.87 | 13.65 | 98.41 | 13.55 | 97.69 | 13.59 | 97.98 |
| A-4 | | | | | | | |
| Formulation | 25.03 | 23.90 | 95.49 | 22.78 | 91.01 | 22.15 | 88.49 |
| B-1 | | | | | | | |
| Formulation | 26.53 | 25.47 | 96.00 | 25.46 | 95.97 | 25.20 | 94.99 |
| B-2 | | | | | | | |
| Formulation | 25.16 | 24.63 | 97.89 | 24.28 | 96.50 | 24.28 | 96.50 |
| B-3 | | | | | | | |
| Formulation | 35.06 | 33.31 | 95.01 | 32.08 | 91.50 | 31.03 | 88.51 |
| C-1 | | | | | | | |
| Formulation | 35.85 | 35.35 | 98.61 | 34.52 | 96.29 | 33.73 | 94.09 |
| C-2 | | | | | | | |
| Formulation | 34.91 | 34.32 | 98.31 | 34.21 | 97.99 | 33.69 | 96.51 |
| C-3 | | | | | | | |
| Arysta | 14.38 | 13.87 | 96.45 | 13.59 | 94.51 | 12.64 | 87.90 |
| Select ® | | | | | | | |
| lot 6F80524000 | | | | | | | |
| Arysta | 12.67 | 12.51 | 98.74 | 12.25 | 96.69 | 11.14 | 87.92 |
| Select ® | | | | | | | |
| lot 6F70507000 | | | | | | | |
| Valent Select | 15.62 | 15.63 | 100.06 | 15.37 | 98.40 | 12.05 | 77.14 |
| Max ™ - lot | | | | | | | |
| 16500338129C | | | | | | | |
| Valent Select | 15.37 | 15.08 | 98.11 | 14.86 | 96.68 | 11.64 | 75.73 |
| Max ™ - lot | | | | | | | |
| 16500298122C | | | | | | | |
| Helena | 14.53 | 14.12 | 97.18 | 13.67 | 94.08 | 12.45 | 85.68 |
| Clethodim | | | | | | | |
| 1E, lot | | | | | | | |
| 06238-GV-A | | | | | | | |

No significant loss of the active ingredient, clethodim, in formulations containing a stabilizer, Paraplex G-60 or Paraplex G-62, is illustrated in Examples 1 and 2. Accordingly, it is demonstrated herein that the formulations containing elethodim, and Paraplex G-60 or Paraplex G-62 are stable for at least two years.

### Example 3

Below are examples of stability studies with unstabilized clethodim.

Study 1

The storage stability of clethodim (Select 2E) (26.4% active ingredient) was reported. The results suggest a loss or degradation of clethodim of 6.49% active ingredient during the first year of storage period and 9.44% active ingredient during the second year of storage period.

Study 2

The stability in sunlight (UV) of clethodim (technical) (95.3% active ingredient) was reported. The results suggest a loss or degradation of clethodim of 42.33% active ingredient after the end of the second year of storage period. The results also suggest the half-life of clethodim technical is 8.4, 1.2 and 0.7 months at 20° C., 38° C. and 50° C. respectively.

Study 3

Clethodim (Select 1E)—non stabilized

7.97% a.i. loss after 1 year

21.8% a.i. loss after 2 years

What is claimed is:

1. A composition comprising:
a cyclohexanedione oxime or an agriculturally acceptable salt thereof, and
an effective amount of a stabilizer comprising an epoxidized oil fatty acid or an epoxidized ester of a fatty acid.

2. The composition of claim 1, further comprising a diluent.

3. The composition of claim 1, further comprising one or more adjuvants.

4. The composition of claim 3, wherein the diluent is a non-polar solvent.

5. The composition of claim 4, wherein the non-polar solvent is an aliphatic hydrocarbon, an aromatic hydrocarbon, or an alkyl ester.

6. The composition of claim 5, wherein the non-polar solvent is an aromatic hydrocarbon.

7. The composition of claim 6, wherein the aromatic hydrocarbon is benzene, toluene, xylene, a substituted or an unsubstituted naphthalene, a monoalkylated aromatic, a polyalkylated aromatic, or mixtures thereof.

8. The composition of claim 5, wherein the non-polar solvent is an alkyl ester.

9. The composition of claim 8, wherein the alkyl ester is a methyl ester.

10. The composition of claim 9, wherein the alkyl ester is a methyl ester of plant oil.

11. The composition of claim 10, wherein the plant oil is canola, linseed, safflower, soybean or a sunflower oil.

12. The composition of claim 2, wherein the one or more adjuvant comprises a crop oil.

13. The composition of claim 2, wherein the one or more adjuvant comprises a surfactant.

14. The composition of claim 13, wherein the surfactant comprises an anionic surfactant, a nonionic surfactant, or a mixture thereof.

15. The composition of claim 14, wherein the anionic surfactant is selected from the group consisting of phosphoric mono- and di-esters of long-chain alcohols having 14 to 22 carbon atoms and the salts thereof, phosphoric mono- and di-esters of alkylene oxide addition products of long-chain alcohols having 14 to 22 carbon atoms and the salts thereof, alkylsulfates having 14 to 22 carbon atoms, polyoxyethylene alkyl ether sulfates of alcohols having 14 to 22 carbon atoms, alkane sulfonates having 14 to 22 carbon atoms, and olefin sulfonates having 14 to 22 carbon atoms.

16. The composition of claim 14, wherein the nonionic surfactant is selected from the group consisting of ethoxylated fatty acids, alcohol ethoxylates, tristyrylphenol ethoxylates, ethoxylated sorbitan fatty acid esters, and mixtures thereof.

17. The composition of claim 16, wherein the nonionic surfactant is ethoxylated fatty acids.

18. The composition of claim 17, wherein the ethoxylated fatty acids is castor oil ethoxylates.

19. The composition of claim 1, comprising between 0.1% and 95% by weight of the cyclohexanedione oxime or an agriculturally acceptable salt or metal complex thereof.

20. The composition of claim 1, comprising between 20 g/L to 800 g/L of the cyclohexanedione oxime or an agriculturally acceptable salt or metal complex thereof.

21. The composition of claim 1, comprising between 0.1% and 15% by weight of the stabilizer.

22. The composition of claim 13, comprising between 0.1 to about 30% by weight of the surfactant.

23. The composition of claim 1, comprising between 1% to 99% by weight of the solvent.

24. The composition of claim 1, comprising between 30% to 80% by weight of the solvent.

25. The composition of claims 1-24, wherein the cyclohexanedione oxime or agriculturally acceptable salt thereof is selected from the group consisting of methyl(E)-(RS)-3-[1-(alloxyimino)butyl]-4-hydroxy-6,6-dimethyl-2-oxocyclohex-3-enecarboxy-late), 5-(3-butyryl-2,4,6-trimethylphenyl)-2-(1-ethoxyiminopropyl)-3-hydroxycyclohex-2-enone), (2-{1-[2-(4-chlorophenoxy)propoxyimino]butyl}-3-hydroxy-5-thian-3-ylcyclohex-2-enone), (±)-2-[(E)-1-[(E)-3-chloroallyloxyimino]propyl]-5-[2-(ethylthio)propyl]-3-hydroxycyclohex-2-enone), (±)-2-[1-(ethoxyimino)butyl]-3-hydroxy-5-thian-3-ylcyclohex-2-enone), (±)-(EZ)-2-(1-ethoxyiminobutyl)-5-[2-(ethylthio)propyl]-3-hydroxycyclohex-2-enone), (EZ)-(RS)-2-{1-[(2E)-3-chloroallyloxy-imino]propyl}-3-hydroxy-5-perhydropyran-4-ylcyclo-hex-2-en-1-one), 2-[1-(ethoxyimino)propyl]-3-hydroxy-5-mesitylcyclohex-2-enone), and 2-[1-[[2-(4-chlorophenoxy)propoxy]imino]butyl]-3-hydroxy-5-(tetrahydro-2H-thiopyran-3-yl)-2-cyclohexen-1-one.

26. The composition of claims 1-24, wherein the cyclohexanedione oxime or agriculturally acceptable salt thereof comprises (±)-2-[(E)-1-[(E)-3-chloroallyloxyimino]propyl]-5-[2-(ethylthio)propyl]-3-hydroxycyclohex-2-enone), or a salt thereof.

27. The composition of claims 1-24, wherein the composition comprises an emulsifiable concentrate, wettable powder, granule, pellet, dust, oil or aerosol.

28. A method of controlling weeds, said method comprising applying of a composition comprising a cyclohexanedione oxime or an agriculturally acceptable salt thereof, and an effective amount of a stabilizer comprising an epoxidized oil fatty acid or an epoxidized ester of a fatty acid to a weed, a crop, or an habitat area.

29. The method of claim 28, wherein the composition further comprises a diluent.

30. The method of claim 28, wherein the composition further comprises one or more adjuvants.

31. The method of claim 28, wherein the cyclohexanedione oxime or, agriculturally acceptable salt thereof is selected from the group consisting of methyl(E)-(RS)-3-[1-(alloxyimino)butyl]-4-hydroxy-6,6-dimethyl-2-oxocyclohex-3-enecarboxy-late), 5-(3-butyryl-2,4,6-trimethylphenyl)-2-(1-ethoxyiminopropyl)-3-hydroxycyclohex-2-enone), (2-{1-[2-(4-chlorophenoxy)propoxyimino]butyl}-3-hydroxy-5-thian-3-ylcyclohex-2-enone), (±)-2-[(E)-1-[(E)-3-chloroallyloxyimino]propyl]-5-[2-(ethylthio)propyl]-3-hydroxycyclohex-2-enone), (±)-2-[1-(ethoxyimino)butyl]-3-hydroxy-5-thian-3-ylcyclohex-2-enone), (±)-(EZ)-2-(1-ethoxyiminobutyl)-5-[2-(ethylthio)propyl]-3-hydroxycyclohex-2-enone), (EZ)-(RS)-2-{1-[(2E)-3-chloroallyloxy-imino]propyl}-3-hydroxy-5-perhydropyran-4-ylcyclo-hex-2-en-1-one), 2-[1-(ethoxyimino)propyl]-3-hydroxy-5-mesitylcyclohex-2-enone), and 2-[1-[[2-(4-chlorophenoxy)propoxy]imino]butyl]-3-hydroxy-5-(tetrahydro-2H-thiopyran-3-yl)-2-cyclohexen-1-one.

32. The method of claim 28, wherein the cyclohexanedione oxime or agriculturally acceptable salt thereof comprises (±)-2-[(E)-1-[(E)-3-chloroallyloxyimino]propyl]-5-[2-(ethylthio)propyl]-3-hydroxycyclohex-2-enone), or a salt thereof.

33. The method of claim 28, wherein the weed is a grass plant.

34. The method of claim 33, wherein the grass plant is selected from the group consisting of Barley, Barnyard grass, Bermudagrass, Broadleaf Signalgrass, Bromes, Corn, Crabgrasses, Crowfootgrass, Fall Panicum, Fescue, Foxtail Barley, Foxtails, Green foxtail, Goosegrass, Grain Sorghum, Itchgrass, Junglerice, Large Crabgrass, Lovegrass, Oats, Orchardgrass, Perennial grasses, Quackgrass, Persian Darnel, Proso Millet, Red Rice, Rhizome Johnsongrass, Rye, Rygrasses, Seedling Johnsongrass, Shattercane, Smooth Crabgrass, Southwestern Cupgrass, Sprangetops, Texas Panicum, Volunteer Barley, Volunteer Oats, Volunteer Con, Volunteer Canary Seed, Volunteer Wheat, Wheat, Wild Oats, Wild Proso Millet, Witchgrass, Woolly Cupgrass, Wirestem Muhly, and Yellow Foxtail.

35. The method of claim 28, wherein the composition is applied as a post-emergence treatment.

36. The method of claim 28, wherein the composition is applied to a crop plant in need of weed control or at risk of undesirable weeds.

37. The method of claim 36, wherein the crop plant is any of canola, flax, peas, lentils, beans, linola, mustard, chickpeas, sunflowers, potatoes, seedling alfalfa, onions, and soybeans.

38. A method for producing a stabilized herbicidal composition comprising mixing a cyclohexanedione oxime with one or more stabilizers thereby producing a stabilized composition.

39. A method for producing a stabilized composition comprising:
a) mixing one or more stabilizers with a diluent to form a first mixture;
b) adding one or more adjuvants to the first mixture to form a second mixture; and
c) adding a cyclohexanedione oxime to the second mixture, thereby producing a stabilized composition.
